(19) United States
(12) Patent Application Publication
(10) Pub. No.: US 2016/0139961 A1
(43) Pub. Date: May 19, 2016

(54) EVENT SUMMARY MODE FOR TRACING SYSTEMS

(71) Applicant: International Business Machines Corporation, Armonk, NY (US)

(72) Inventors: Luc Bertin, Cantley (CA); Ricardo Borba, Ottawa (CA); Alagesan Krishnapillai, Kanata (CA); Anatoly Tulchinsky, Nepean (CA)

(21) Appl. No.: 14/663,478

(22) Filed: Mar. 20, 2015

Related U.S. Application Data
(63) Continuation of application No. 14/547,514, filed on Nov. 19, 2014.

(51) Int. Cl. G06F 9/50; G06F 9/54

(52) U.S. Cl. CPC G06F 9/5083; G06F 9/542

(57) ABSTRACT

Reducing resource requirements in an instrumented process tracing system, a process having a top instrumented process and a nested hierarchy of instrumented sub-processes. A computer receives a plurality of instrumented process data from the top process and the sub-processes, each datum including a process identifier, a process type, a top process identifier, and a process completion elapsed time. Based on the computer determining that the process identifier and the top process identifier in the datum received are equivalent: if the process completion elapsed time in the datum received is determined to be less than a threshold value, the computer writes a summary of the plurality of instrumented process data to a data store, and if the process completion elapsed time in the datum received is determined to not be less than the threshold value, the computer writes the plurality of instrumented process data to the data store.

Aspects of the present invention have been disclosed by the Applicant, who obtained the subject matter disclosed directly from the inventors, in the demonstration of product IBM Business Intelligence Pattern with BLU Acceleration V1.1, made available to the public on May 19, 2014.

### BACKGROUND

The present disclosure relates generally to data processing and file management and more particularly to log management.

A computer log is a chronicle of computer activity used for statistical purposes as well as backup and recovery. Any program might generate a log file for purposes such as recording incoming dialogs, recording error and status messages, recording program execution flow, and recording program events. An operating system or application log file may be analyzed for trends, for diagnosing errors, for identifying process congestion points, for auditing, and for identifying program execution flow.

### SUMMARY

Embodiments of the present invention disclose a method, computer program product, and system for reducing resource requirements in an instrumented process tracing system, a process having a top instrumented process and a nested hierarchy of instrumented sub-processes. A computer receives a plurality of instrumented process data from the top process and the sub-processes, each datum including a process identifier, a process type, a top process identifier, and a process completion elapsed time. Based on the computer determining that the process identifier and the top process identifier in the datum received are equivalent: if the process completion elapsed time in the datum received is determined to be less than a threshold value, the computer writes a summary of the plurality of instrumented process data to a data store, and if the process completion elapsed time in the datum received is determined to not be less than the threshold value, the computer writes the plurality of instrumented process data to the data store.

In another aspect of the invention, the summary of the plurality of instrumented data comprises a statistical summarization of the process completion elapsed times from the plurality of instrumented data.

In another aspect of the invention, writing to the data store the summary of the plurality of instrumented process data further comprises the computer summing the process completion elapsed times from the plurality of instrumented process data by process type, writing the summation of process completion elapsed times for one or more process types to the data store, and discarding the remaining instrumented process data.

### BRIEF DESCRIPTION OF THE SEVERAL VIEWS OF THE DRAWINGS

Features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts an exemplary nested hierarchy of events, in accordance with an embodiment of the present disclosure;

FIG. 2 illustrates a functional block diagram of an exemplary distributed tracing environment, in accordance with an embodiment of the present disclosure;

FIG. 3 depicts an exemplary summarized hierarchy of events, in accordance with an embodiment of the disclosure;

FIGS. 4A and 4B are a flowchart illustrating trace system log management using event summary mode, in accordance with an embodiment of the disclosure; and

FIG. 5 depicts a block diagram of components of a computing device, in accordance with an embodiment of the disclosure.

### DETAILED DESCRIPTION

Systems and applications may log events for future analysis. Some systems and applications may log error events for debugging; other systems and applications may log program execution time, or elapsed time, for trending, auditing, or response time (or system health) analysis.

A distributed tracing system, such as a Business Intelligence (BI) system or an online retail system, may log the elapsed times of a plurality of disparate processes involved in executing a distributed tracing system request, such as a request to run a BI report or a request to complete an online retail customer purchase. A distributed tracing system request may initiate the execution of multiple processes needed to finalize the request, all of which may be required to complete before the request itself completes.

Running an exemplary BI distributed tracing system report may require the completion of a plurality of processes, such as querying one or more databases, fetching the query results, processing the query results, and rendering charts based on the query results, before the report request itself can complete. During the running of the report, the BI distributed tracing system may gather and log elapsed times for this plurality of processes.

Finalizing an exemplary online retailer distributed tracing system customer's “checkout” may also require the completion of a plurality of processes before the “checkout” request completes. The retailer's “checkout” may include checking store inventory and validating the customer's credit card information. The retailer's distributed tracing system may gather and log the elapsed times for these processes for each “checkout” requested.

The processes, or events, associated with a distributed tracing system request may themselves initiate additional sub-processes, or events, creating a nested hierarchy of events, all of whose elapsed times, for example, may be instrumented (or monitored), gathered and logged by the distributed tracing system.

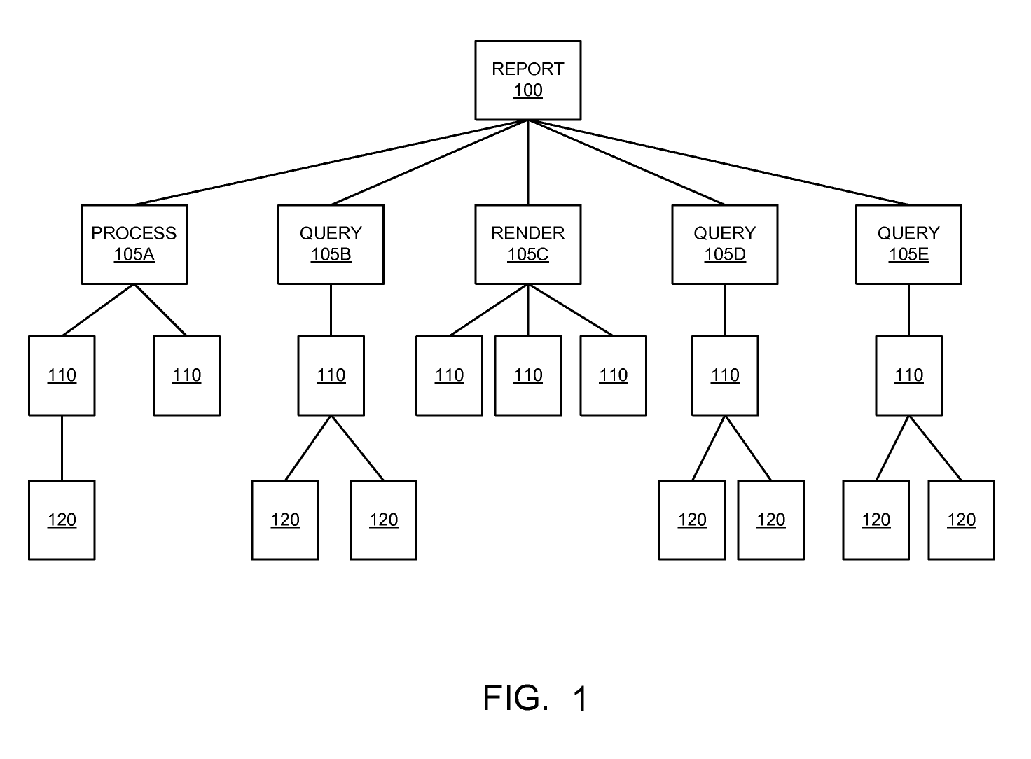

FIG. 1 depicts an exemplary nested hierarchy of events associated with an exemplary BI report request, in accordance with an embodiment of the present disclosure. In the exemplary hierarchy, the BI report request may initiate events 100, 105A, 105B, 105C, 105D, 105E, that query databases, process the query results, and render charts based on the query results before producing the report. The initiated events 105 may further initiate additional events 110, as needed, which may themselves initiate other events 120, as needed, creating a hierarchy of parent events 100, 105, 110 and child events 105, 110, 120 that together contribute to the elapsed time for executing the original report request. Each parent event 100, 105, 110 may require its child events 105, 110, 120 to complete prior to completing itself. In the exemplary embodiment, a request to run the exemplary BI report initiates twenty-one events 100, 105, 110, 120 that may be traced, and twenty-one events 100, 105, 110, 120 whose individual execution elapsed times may be logged by the BI distributed tracing system.

Analysis of logged, elapsed time data may identify long running programs, slow processes, and bottlenecks that slow the response time of a request, an application, or an entire operating system. Analysis of elapsed time log entries, for events that execute on multiple systems connected over a network, may identify a slow running system in the distributing tracing system network and network congestion.

If the exemplary BI report request of FIG. 1 takes an average of ten seconds to complete, and this exemplary report requires twenty-one events 100, 105, 110, 120 to complete prior to completing the report, twenty-one elapsed time entries may be logged every ten seconds. For a BI distributed tracing system without congestion bottlenecks or errors whose average report request completion time is half a second, 21×20=420 elapsed time entries may be logged during that same ten second interval. In a well running distributed tracing system, as response times decrease, the number of elapsed time entries logged increase, increasing the processor cycles and storage utilized to log the elapsed time data, even though the logged data may be uninteresting for later analysis due to the lack of congestion or errors. A distributed tracing system that executes without congestion bottlenecks or errors, and whose requests initiate hundreds or thousands of events, may gather and log enough event elapsed time data to overload the system and the system's log storage. This large amount of logged data may also add unnecessary processor cycle utilization during analysis to analyze all the potentially uninteresting data.

Distributed tracing systems like Google's Dapper and Twitter's Zipkin implement a sampling algorithm to limit the amount of processor cycles and storage utilized for logging gathered data in order to minimize the performance impact of data collection. This approach randomly discards data, including unusually large elapsed time data that may ordinarily be useful for analysis and which may indicate a problem with an event. Discarding data may also prevent these distributed tracing systems from providing precise trend measurements of resource utilization as the discarded data cannot be included in the measurements.

Embodiments of the present disclosure, using “event summary mode,” may likewise reduce the amount of gathered data that is logged, reducing the amount of processor cycles and storage utilized for logging the gathered data. Various event summary mode embodiments may reduce logging without the precision loss of the sampling systems described above. Embodiments of the present disclosure may log a summary of event elapsed time data when requests complete within a defined acceptable elapsed time, logging the complete hierarchy of gathered elapsed time data only when a request takes longer to complete than the defined acceptable threshold. A request that performs well may never be analyzed since it exhibits no problems. For these well performing requests, the summarized event elapsed time data, logged by various embodiments of the disclosure, may provide the precision required for trending, user activity, and system health analysis, while also reducing processor cycles and log storage for the request.

Although the exemplary embodiments in this disclosure describe a distributed tracing system, event summary mode may be advantageously utilized by any system or application that monitors and logs initiated process elapsed time in which the initiated processes themselves initiate a hierarchical set of monitored, timed, and logged processes whose elapsed times contribute to the total elapsed time of the initiating process.

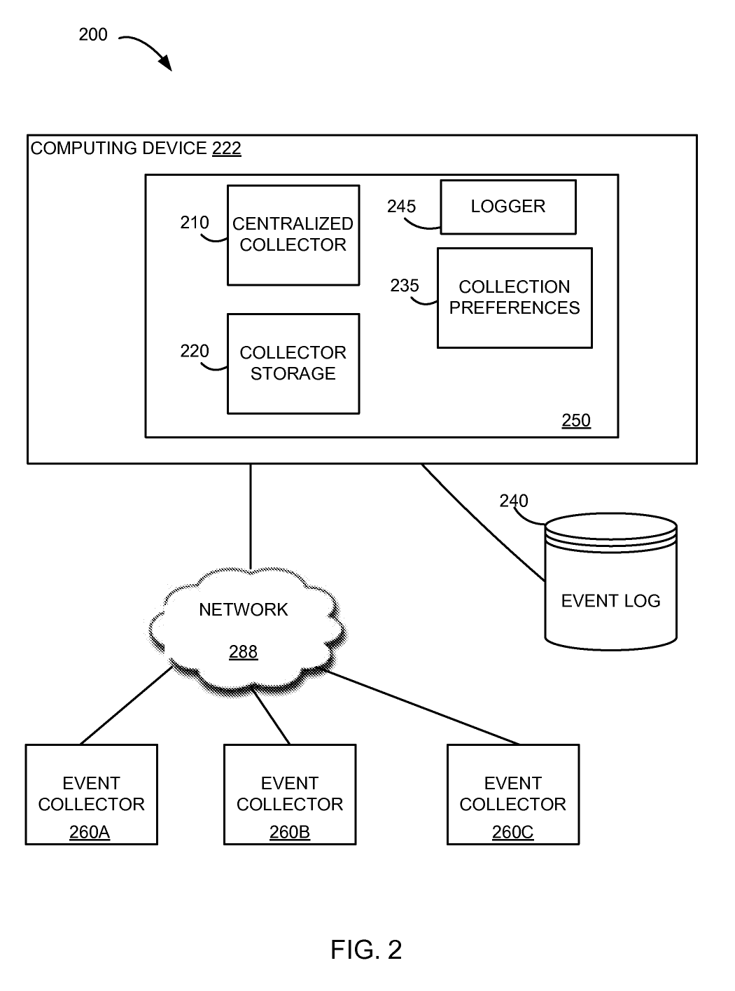

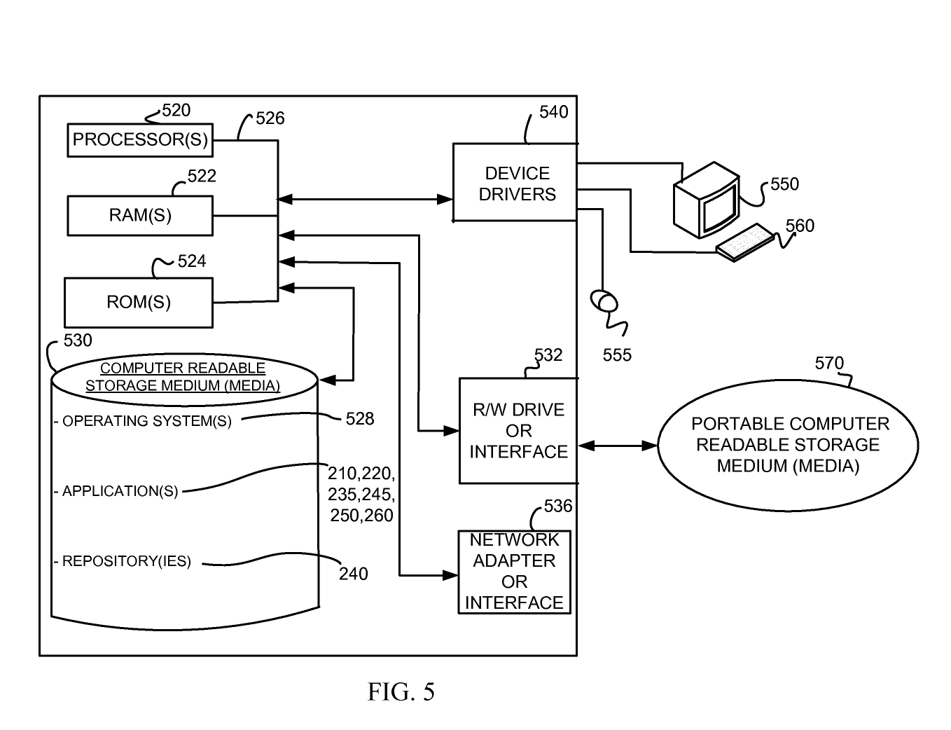

FIG. 2 illustrates a functional block diagram of an exemplary distributed tracing environment 200 in which a computing device 222 is configured, in accordance with an embodiment of the present disclosure. Computing device 222 may include a distributed tracing system 250 which includes a centralized collector 210, collector storage 220, collection preferences 235, logger 245, and event log 240, all of which may be stored, for example, on a computer readable storage medium, such as computer readable storage medium (media) 530 (FIG. 5), portable computer readable storage medium (media) 570, and/or RAM(S) 522.

Computing device 222, may in various embodiments, be connected to a plurality of event collectors 260A, 260B, 260C, which may be locally attached to computing device 222 or may be externally accessed through a network 288 (for example, the Internet, a local area network or other, wide area network or wireless network) and network adapter or interface 536 (FIG. 5). The network may comprise copper wires, optical fibers, wireless transmission, routers, firewalls, switches, gateway computers, and/or edge servers.

In various embodiments, collection preferences 235 may include, but are not limited to, a threshold value of acceptable request completion elapsed time for distributed tracing system 250 requests, a value indicating a time interval between scheduled log data collections, and event types to be summarized rather than logged for requests completing in less time than the threshold value. Each type of request issued by distributed tracing system 250 may have a unique threshold value and unique event types specified in collection preferences 235. The threshold value, event types, and log data collection time interval value, in collection preferences 235, may be pre-defined by distributed tracing system 250 or may be specified, for example, through a distributed tracing system 250 configuration parameter or command. It should be noted that the elapsed time threshold value should be less than the scheduled log collection interval value to allow well running requests to complete between scheduled log collections.

Event collectors 260 may, in various embodiments, collect data for the event they monitor. Event collectors 260 may execute locally on the same computing device 222 that issued the distributed tracing system 250 request, or may execute on remote devices and connect with distributed tracing system 250 through network 288.

Event collector 260 may create an event record for the event 100, 105, 110, 120 it monitors and transmit the event record to centralized collector 210. The event record may include, but is not limited to, a unique identifier linking the event 100, 105, 110, 120 with its parent event 100, 105, 110, a value indicating the event type, a start date/time, and an event execution elapsed time value. In various embodiments, all event 100, 105, 110, 120 identifiers may also link the event 100, 105, 110, 120 to its initial distributed tracing system 250 request. Child events 105, 110, 120 may execute in parallel, but because a parent event 100, 105, 110 may not complete until all its child events 105, 110, 120 complete, the parent event 100, 105, 110 elapsed time may encompass the elapsed time of its longest running child event 105, 110, 120.

In various embodiments, the elapsed time for a request initiated by the distributed tracing system 250 may encompass the elapsed times of all the events 100, 105, 110, 120 that result from that initial request.

In various embodiments, centralized collector 210 may receive event records for each event 100, 105, 110, 120 initiated by the distributed tracing system 250 request from the plurality of event collectors 260 collecting data about each event 100, 105, 110, 120. Centralized collector 210 may store each event record it receives in collector storage 220. Collector storage 220 may be any computer readable storage medium, such as computer readable storage medium (media) 530 (FIG. 5), portable computer readable storage medium (media) 570, and/or RAM(S) 522.

Collector storage 220 may be organized as a table, an ordered list, a linked list, or any organization that allows centralized collector 210 to efficiently associate event records with their initiating request. In certain embodiments, each initiated request may have its own distinct collector storage 220.

In various embodiments, centralized collector 210 may periodically harden the event records in collector storage 220 by writing them to event log 240, described in more detail below. In certain other embodiments, centralized collector 210 may harden the event records when the request completes. In various embodiments, event records in collector storage 220 may be cleared or overwritten after they are successfully written to event log 240.

Either periodically, or when a request completes, centralized collector 210 may, in various embodiments, utilize the threshold value in collection preferences 235 to determine if the request completed within the acceptable request completion elapsed time. For well running requests that complete within the acceptable elapsed time threshold, centralized collector 210 may summarize the plurality of event records associated with the request and write only the summary records to event log 240. In this way, event log 240 entries may continue to be analyzed for trending, system health, and user activity without losing precision. Due to the request performing at an acceptable level, individual event log entries may never be exhaustively analyzed, thus logging only summary entries may not hamper error analysis. Writing only summary log entries to event log 240 may reduce processor cycles and log storage utilization that would ordinarily be required to write and analyze the complete hierarchy of event records.

In certain embodiments, centralized collector 210 may determine which events to summarize from the events to be summarized types defined in collection preferences 235. Centralized collector 210 may search collector storage 220 and sum the elapsed times from event records of each defined event types associated with the well running request, creating a summary event record for each defined event type. Centralized collector 210 may write the summary event record for each defined event type to event log 240. In certain embodiments, for well running requests, centralized collector 210 may bypass the event records in collector storage 220 for all other event types, writing only the summary event records to event log 240.

For a request that does not complete within the acceptable elapsed time threshold, centralized collector 210 may write all the event records in collector storage 220, which are associated with the request to event log 240, providing a complete hierarchy of event records for error analysis.

In various embodiments in which event records from collector storage 220 are periodically hardened to event log 240 rather than hardened upon request completion, logger 245 may receive control from distributed tracing system 250 on a timed basis. The frequency with which logger 245 receives control may depend on the scheduled log data collection time interval value defined in collection preferences 235.

Logger 245 may invoke centralized collector 210 to write log entries, from collector storage 220, to event log 240 for all requests completed since the last scheduled execution of logger 245 to collect log data. Centralized collector 210 may determine which requests saved in collector storage 220, completed since the last scheduled log collection, ran well, as described above, and write only summary event records from collector storage 220 to event log 240. Centralized collector 210 may also determine which requests saved in collector storage 220, completed since the last scheduled log collection, ran poorly, as described above, and log all associated event records from collector storage 220 in event log 240.

Event log 240 may be a repository, a table, a list, a database, or any data organization that may be retrieved and analyzed, for example, for problem identification, trending, system health, and user activity. Event log 240 may be a data store, or any computer readable storage medium, such as computer readable storage medium (media) 530 (FIG. 5), portable computer readable storage medium (media) 570, and/or RAM(S) 522, and may be attached locally to computing device 222 or accessed remotely over network 288.

Computing device 222 represents a computing device, system or environment, and may be a laptop computer, notebook computer, personal computer (PC), desktop computer, tablet computer, thin client, mobile phone or any other electronic device or computing system capable of performing the required functionality of embodiments of the disclosure. Computing device 222 may include internal and external hardware components, as depicted and described in further detail with respect to FIG. 5. In other various embodiments of the present disclosure, computing device 222 may represent a computing system utilizing clustered computers and components to act as a single pool of seamless resources. In general, computing device 222 is representative of any programmable electronic devices or combination of programmable electronic devices capable of executing machine-readable program instructions in accordance with an embodiment of the disclosure.

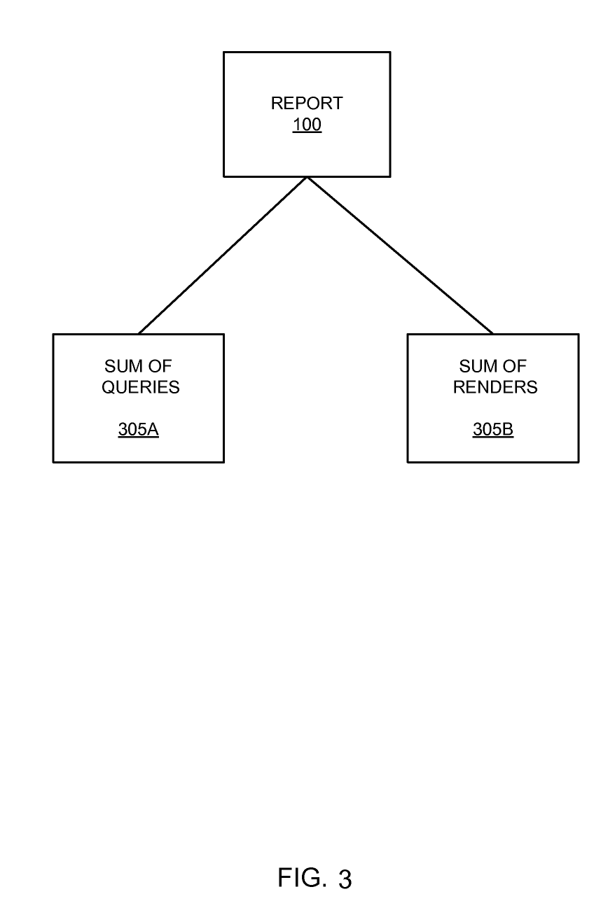

FIG. 3 depicts an exemplary summarized hierarchy of events associated with the exemplary BI report request of FIG. 1, in accordance with an embodiment of the disclosure. In the exemplary summarized hierarchy of events, centralized collector 210 determined that collection preferences 235 values indicated that report, query, and render event types were to be summarized for well running BI report requests and all other event types were to be ignored. Sum of queries 305A may include the sum of the elapsed times from all query 105B, 105D, and 105E event records in the full hierarchy of events of FIG. 1. Sum of renders 305B may include the sum of the elapsed times from all render 105C event records in the full hierarchy of events of FIG. 1. Since only one render 105C was initiated in the exemplary hierarchy of FIG. 1, the elapsed time for exemplary sum of renders 305B may equal the elapsed time from the render 105C event record. The event record for report 100 may include the elapsed time for the completed report request. In the exemplary embodiment, only the three records 100, 305A, 305B may be written to event log 240 for a well running BI report instead of the twenty-one event records of FIG. 1.

For a distributed tracing system 250 that summarizes well running requests, centralized collector 210 may write only 3×20=60 log entries every ten seconds for a report that executes in half a second, rather than the 420 entries written to log the full hierarchy of FIG. 1. Summarizing log data allows a well running distributed tracing system 250 to control the volume of data logged while preserving the precision needed for analyzing trending, user activity and system health.

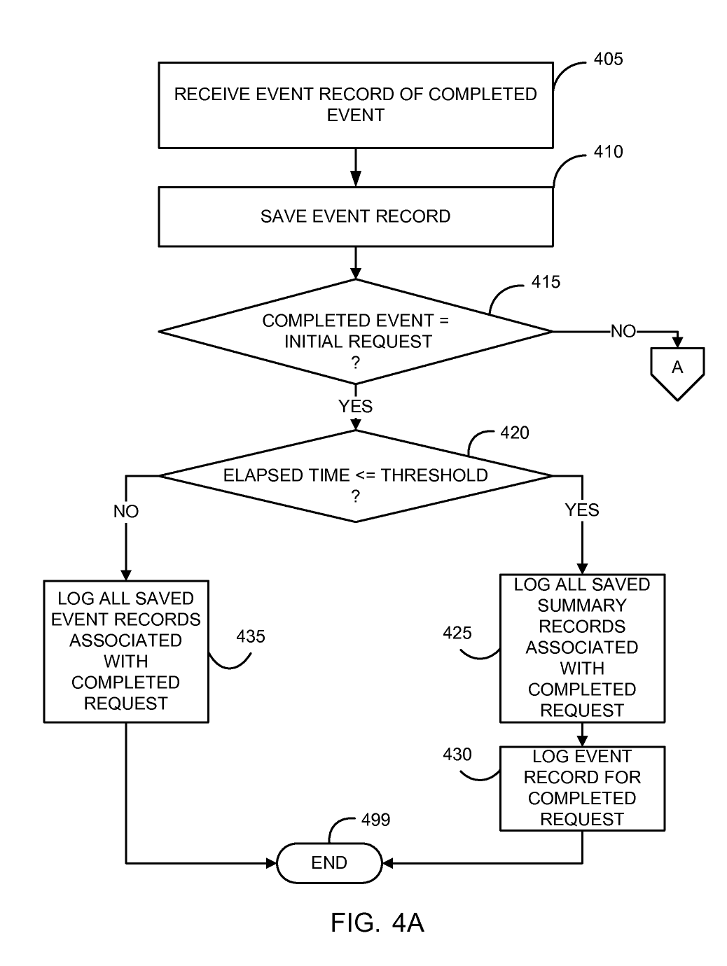

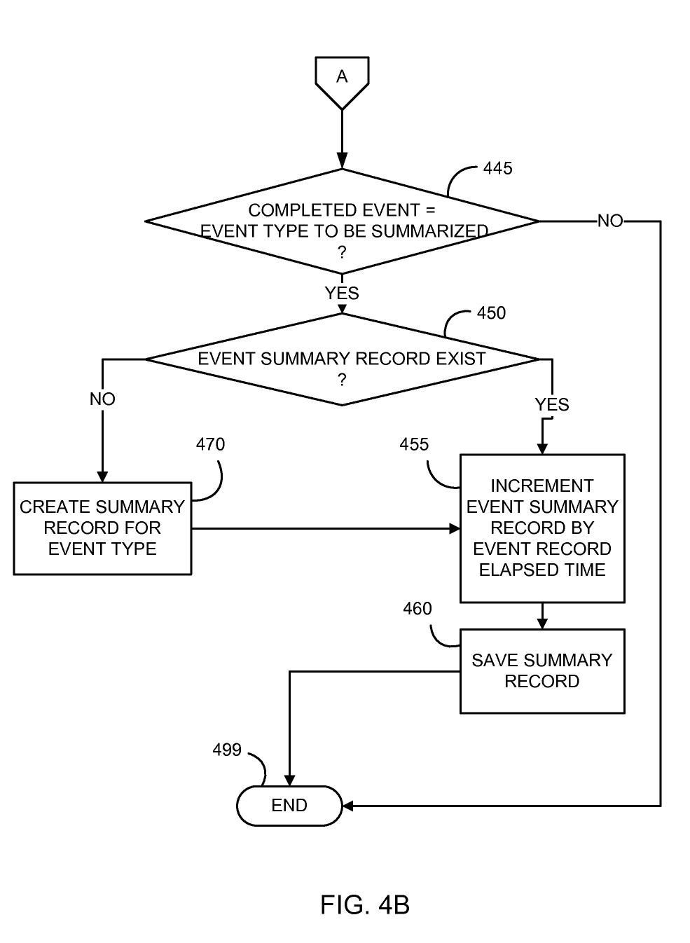

FIGS. 4A and 4B are a flowchart illustrating trace system log management using event summary mode, in accordance with an embodiment of the disclosure. In various embodiments, centralized collector 210 may, at 405, receive an event record for a completed event from an event collector 260 monitoring that event 100, 105, 110, 120. The event record may be for any event 100, 105, 110, 120 in the event hierarchy associated with a distributed tracing system 250 request monitored by centralized collector 210. Centralized collector 210 may, at 410, save the event record in collector storage 220 for later logging to event log 240. If the received event record is the completion event record for the distributed tracing system 250 request itself, as determined at 415, centralized collector 210 determines, at 420, if the request completed within the elapsed time threshold defined for this request type in collection preferences 235.

For a well running request that completed within the elapsed time threshold, as determined at 420, centralized collector 210 may, at 425, harden any summary records that are saved in collector storage 220, and associated with the completed request, by writing the summary records as log entries in event log 240. Centralized collector 210 may also write the received event record for the completed request to event log 240, at 430. Centralized collector 210 may utilize fewer processor cycles and less log storage by writing only the limited number of records to event log 240, rather than writing event records from the entire hierarchy of events 100, 105, 110, 120. Centralized collector 210 completes processing for the received event record, at 499. Centralized collector 210 may wait to receive another event record or may wait to receive control from logger 245, for a scheduled logging of event records.

For a poorly running request that did not complete within the elapsed time threshold, as determined at 420, centralized collector 210 may, at 435, harden all the saved event records, in collector storage 220, for the entire hierarchy of events 100, 105, 110, 120 associated with the completed request, including the received event record for the completed request, by writing them as log entries to event log 240. Logging event records for the entire hierarchy may provide the data necessary to analyze why the request ran poorly. Centralized collector 210 completes its processing for the received event record, at 499. Centralized collector 210 may wait to receive another event record or may wait to receive control from logger 245, for a scheduled logging of event records.

If centralized collector 210 determines, at 415, that the received event record is not the completion event record for the distributed tracing system 250 request itself, centralized collector 210 may determine, at 445, if the completed event type in the event record matches an event type defined in collection preferences 235 for summarization. If the event type is not to be summarized, as determined at 445, centralized collector 210 completes its processing for the received event record, at 499.

If centralized processor 210 determines, at 445, that the event type in the event record is to be summarized and determines, at 450, that a summary record for this event type has not already been created and saved in collector storage 220, centralized collector 210 creates, at 470, a summary record for this event type. If centralized collector 210 has just created a summary record at 470 or has determined, at 450, that a summary record for this event type already exists, centralized collector 210 may, at 455, increment the elapsed time value in the summary record by the elapsed time value in the received event record. Centralized collector 210 may, at 460, save the updated summary record in collector storage 220 and complete its processing for the received event record, at 499.

FIG. 5 depicts a block diagram of components of computing device 222 of FIG. 2, in accordance with an embodiment of the disclosure. It should be appreciated that FIG. 5 provides only an illustration of one implementation and does not imply any limitations with regard to the environments in which different embodiments may be implemented. Many modifications to the depicted environment may be made.

Computing device 222 can include one or more processors 520, one or more computer-readable RAMs 522, one or more computer-readable ROMs 524, one or more computer readable storage medium 530, device drivers 540, read/write drive or interface 532, and network adapter or interface 536, all interconnected over a communications fabric 526. Communications fabric 526 can be implemented with any architecture designed for passing data and/or control information between processors (such as microprocessors, communications and network processors, etc.), system memory, peripheral devices, and any other hardware components within a system.

One or more operating systems 528, distributed tracing systems 250, centralized collectors 210, loggers 245, event collectors 260, collector storages 220, collection preferences 235 and event logs 240 are stored on one or more of the computer-readable storage medium 530 for execution by one or more of the processors 520 via one or more of the respective RAMs 522 (which typically include cache memory). In the illustrated embodiment, each of the computer readable storage medium 530 can be a magnetic disk storage device of an internal hard drive, CD-ROM, DVD, memory stick, magnetic tape, magnetic disk, optical disk, a semiconductor storage device such as RAM, ROM, EPROM, flash memory or any other computer readable storage medium that can store a computer program and digital information.

Computing device 222 can also include a R/W drive or interface 532 to read from and write to one or more portable computer readable storage medium 570. Distributed tracing system 250, centralized collector 210, logger 245, event collector 260, collector storage 220, collection preferences 235 and event log 240 can be stored on one or more of the portable computer readable storage medium 570, read via the respective R/W drive or interface 532, and loaded into the respective computer readable storage medium 530.

Computing device 222 can also include a network adapter or interface 536, such as a TCP/IP adapter card or wireless communication adapter (such as a 4G wireless communication adapter using OFDMA technology). Distributed tracing system 250, centralized collector 210, logger 245, event collector 260, collector storage 220, collection preferences 235 and event log 240 can be downloaded to the computing device from an external computer or external storage device via a network (for example, the Internet, a local area network or other, wide area network or wireless network) and network adapter or interface 536. From the network adapter or interface 536, the programs are loaded into the computer readable storage medium 530. The network may comprise copper wires, optical fibers, wireless transmission, routers, firewalls, switches, gateway computers, and/or edge servers.

Computing device 222 can also include a display screen 550, a keyboard or keypad 560, and a computer mouse or touchpad 555. Device drivers 540 interface to display screen 550 for imaging, to keyboard or keypad 560, to computer mouse or touchpad 555, and/or to display screen 550 for pressure sensing of alphanumeric character entry and user selections. The device drivers 540, R/W drive or interface 532, and network adapter or interface 536 can comprise hardware and software (stored in computer readable storage medium 530 and/or ROM 524).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although preferred embodiments have been depicted and described in detail herein, it will be apparent to those skilled in the relevant art that various modifications, additions, substitutions and the like can be made without departing from the spirit of the invention, and these are, therefore, considered to be within the scope of the invention, as defined in the following claims.

1. A method for reducing resource requirements in an instrumented process tracing system, a process having a top instrumented process and a nested hierarchy of instrumented sub-processes, the method comprising:
receiving, by a computer, a plurality of instrumented process data from the top process and the sub-processes, each datum including a process identifier, a process type, a top process identifier, and a process completion elapsed time;
determining, by the computer, that the process identifier and the top process identifier in the datum received are equivalent;
comparing, by the computer, the process completion time in the datum received to a threshold value; and
writing, by the computer, to a data store, the plurality of instrumented process data or a summary of the plurality of instrumented process data,
wherein the summary of the plurality of instrumented process data is written to the data store based on the process completion elapsed time in the datum received being less than the threshold value, and
wherein the plurality of the instrumented process data is written to the data store based on the process completion elapsed time in the datum received being not less than the threshold value.

2. The method according to claim 1, wherein the summary of the plurality of instrumented data comprises a statistical summarization of the process completion elapsed times from the plurality of instrumented data.

3. The method according to claim 2 wherein writing to the data store the summary of the plurality of instrumented process data further comprises:
summing, by the computer, the process completion elapsed times from the plurality of instrumented process data by process type;
writing to the data store, by the computer, the summation of process completion elapsed times for one or more process types; and
discarding, by the computer, the remaining instrumented process data.

4. The method according to claim 3, wherein the one or more process types whose process completion elapsed time summations are written to the data store is configurable.

5. The method according to claim 3, wherein the process types whose elapsed times are to be summed is configurable.

6. The method according to claim 1, wherein the threshold value is configurable.
